(19) United States
(12) Patent Application Publication
(10) Pub. No.: US 2017/0010725 A1
(43) Pub. Date: Jan. 12, 2017

(54) TOUCH DISPLAY PANEL STRUCTURE AND TOUCH DISPLAY PANEL

(71) Applicants: General Interface Solution Limited, Miaoli County (TW); Interface Optoelectronics (ShenZhen) Co., Ltd., Shenzhen (CN)

(72) Inventors: Chun-Chi CHEN, Guangdong (CN); Shang-Yu HUANG, Guangdong (CN); Chen-You CHEN, Guangdong (CN)

(21) Appl. No.: 14/949,904

(22) Filed: Nov. 24, 2015

(30) Foreign Application Priority Data
Jul. 7, 2015 (CN) 201510393855.X

(51) Int. Cl. G06F 3/041

(52) U.S. Cl. CPC G06F 3/0412; G06F 2203/04112

(57) ABSTRACT

A touch display panel structure includes a display panel and a first metal mesh. The display panel includes a plurality of pixel units, and the pixel units respectively have a first length along a horizontal direction. The first metal mesh is disposed on the display panel. The first metal mesh includes a plurality of first metal mesh units, and the first metal mesh units respectively have a second length along the horizontal direction. The second length is about 4.15 to about 5.2 times the first length.

### RELATED APPLICATIONS

This application claims priority to Chinese Application Serial Number 201510393855.X, filed Jul. 7, 2015, which is herein incorporated by reference.

### BACKGROUND

1. Field of Invention

The present invention relates to a touch display panel structure. More particularly, the present invention relates to a touch display panel structure using a metal mesh.

2. Description of Related Art

The metal mesh is a touch technology in which extremely fine metal wires (can not be seen with a naked eye) are designed in a mesh, and the metal wires are utilized to detect positions of touch objects. As compared with an indium tin oxide (ITO) electrode, a metal mesh having a low impedance, a low manufacturing cost, good transparency, and high flexibility, is suitable for being applied to large-sized display screens, such as a notebook computer.

Although the metal wires of the metal mesh are extremely fine, the metal wires themselves are opaque. Hence, the display screen is likely to have an uneven brightness (mura) phenomenon because the display screen is blocked by the metal mesh, which results in different aperture ratios of pixels.

For the forgoing reasons, there is a need to solve the above-mentioned problem by providing a touch display panel utilizing a metal mesh with improved characteristics, which is also an object that the industry is eager to achieve.

### SUMMARY

One aspect of the present invention is to provide a touch display panel structure to allow brightness of a display picture to be uniform and to improve display brightness.

A touch display panel structure is provided. The touch display panel structure comprises a display panel and a first metal mesh. The display panel comprises a plurality of pixel units. The pixel units respectively have a first length along a horizontal direction. The first metal mesh is disposed on the display panel. The first metal mesh comprises a plurality of first metal mesh units. The first metal mesh units respectively have a second length along the horizontal direction. The second length is about 4.15 to about 5.2 times the first length.

In the foregoing, the second length is about 4.15 to about 5 times the first length.

In the foregoing, the second length is about 4.3 to about 5.2 times the first length.

In the foregoing, the second length is about 4.5 to about 5.2 times the first length.

In the foregoing, the first length is about 45 to about 90 μm.

In the foregoing, the second length is about 185 to about 470 μm.

In the foregoing, the first metal mesh units are in a rectangular shape or in a diamond shape.

In the foregoing, the pixel units further have a third length along a vertical direction, respectively. The first metal mesh units further have a fourth length along the vertical direction, respectively. The fourth length is about 4.15 to about 5.2 times the third length.

In the foregoing, the fourth length is about 4.15 to about 5 times the third length.

In the foregoing, the fourth length is about 4.3 to about 5.2 times the third length.

In the foregoing, the fourth length is about 4.5 to about 5.2 times the third length.

The invention provides a touch display panel. The touch display panel comprises the above touch display panel structure, a touch substrate, and a second metal mesh. The touch substrate is disposed on the first metal mesh. The second metal mesh is disposed on the touch substrate. The second metal mesh comprises a plurality of second metal mesh units. The second metal mesh units respectively have a fifth length along the horizontal direction. The fifth length is about 4.15 to about 5.2 times the first length.

In the foregoing, the fifth length is about 4.15 to about 5 times the first length.

In the foregoing, the fifth length is about 4.3 to about 5.2 times the first length.

In the foregoing, an orthogonal projection of the first metal mesh units on the display panel is interlaced with an orthogonal projection of the second metal mesh units on the display panel.

According to the embodiments of the present invention, the second length of the first metal mesh unit is rendered to be about 4.15 to about 5.2 times the first length of the pixel unit. As a result, a distribution of the pixel units having a decreased aperture ratio due to the blockage of the pixel units by the metal wires of the first metal mesh and the pixel units not being blocked by the metal wires of the first metal mesh is more uniform. A naked eye will not observe the mura phenomenon of the display picture. At the same time, since the distribution of the first metal mesh units is much more sparse than that of the pixel units, the blockage of the display panel by the first metal mesh is reduced to effectively increase the average aperture ratio of the pixel units so as to improve the display brightness of the touch display panel structure.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 depicts a top schematic diagram of a touch display panel structure when displaying a pure green picture according to one embodiment of this invention;

FIG. 2 depicts a top schematic diagram of a pixel unit of a touch display panel structure according to one embodiment of this invention;

FIG. 3 depicts a top schematic diagram of a touch display panel structure when displaying a pure green picture according to another embodiment of this invention;

FIG. 4 depicts a top schematic diagram of a touch display panel when displaying a pure green picture according to one embodiment of this invention; and

FIG. 5 depicts a cross-sectional schematic diagram of the touch display panel of FIG. 4.

### DESCRIPTION OF THE EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and elements are schematically depicted in order to simplify the drawings.

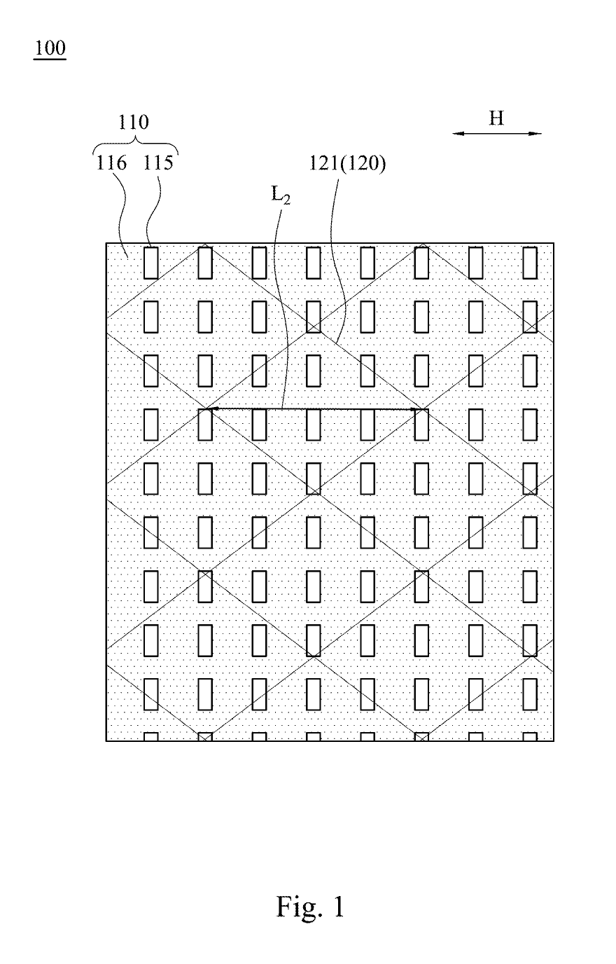

FIG. 1 depicts a top schematic diagram of a touch display panel structure 100 when displaying a pure green picture according to one embodiment of this invention. Various embodiments of the present invention provide a touch display panel structure 100. The touch display panel structure 100 is mainly a touch display panel structure utilizing a metal mesh.

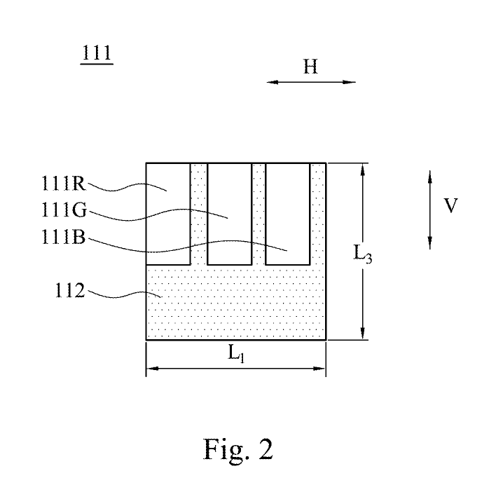

FIG. 2 depicts a top schematic diagram of a pixel unit 111 of the touch display panel structure 100 according to one embodiment of this invention. As shown in FIG. 1 and FIG. 2, the touch display panel structure 100 comprises a display panel 100 and a first metal mesh 120. The display panel 110 comprises a plurality of pixel units 111. The pixel units 111 respectively have a first length L1 along a horizontal direction H. The first metal mesh 120 is disposed on the display panel 110. The first metal mesh 120 comprises a plurality of first metal mesh units 121. The first metal mesh units 121 respectively have a second length L2 along the horizontal direction H. The second length L2 is about 4.15 to about 5.2 times the first length L1.

In greater detail, as shown in FIG. 2, the pixel unit 111 comprises a red sub-pixel 111R, a green sub-pixel 111G, a blue sub-pixel 111B, and a non-light emitting area 112. As shown in FIG. 1 and FIG. 2, when the touch display panel structure 100 displays a pure green picture, only the green sub-pixel 111G of the pixel unit 111 luminates. Hence, the green sub-pixel 111G in each of the pixel units 111 forms a bright area 115 in FIG. 1, and the other area (that is, the red sub-pixel 111R, the blue sub-pixel 111B, and the non-light emitting area 112) in each of the pixel units 111 forms a dark area 116 (it is noted that display quality of the touch display panel structure 100 is usually tested when the touch display panel structure 100 displays the pure green picture since a human eye is most sensitive to green light) in FIG. 1.

Because metal wires of the first metal mesh 120 themselves are opaque, aperture ratios of the pixel units 111 are likely different caused by blockage of the pixel units 111 by the first metal mesh 120. The mura phenomenon of the display screen thus occurs. For example, when the touch display panel structure 100 displays the pure green picture, a naked eye will observe the mura phenomenon of the display screen if the second length L2 of the first metal mesh unit 121 is greater than 6 times the first length L1 of the pixel unit 111. Hence, the second length L2 of the first metal mesh unit 121 is designed to be smaller than 5.2 times the first length L1. As a result, a distribution of the pixel units 111 having a decreased aperture ratio due to the blockage of the pixel units 111 by the metal wires and the pixel units 111 not being blocked by the metal wires is more uniform. A naked eye will not observe the mura phenomenon of the display picture (in other words, since a number of the pixel units 111 not being blocked by the metal wires between the pixel units 111 having the reduced aperture ratio due to the blockage of the pixel units 111 by the metal wires is less, a naked eye is not able to identify the difference under the circumstances that the darker pixel units 111 will mix with the pixel units 111 having a normal brightness).

In addition, since the second length L2 is greater than 4.15 times the first length L1, a distribution of the first metal mesh units 121 is much more sparse than that of the pixel units 111. The blockage of the display panel 110 by the first metal mesh 120 is therefore reduced to increase an average aperture ratio of the pixel units 111 so as to improve the display brightness of the touch display panel structure 100.

A relationship between the first length L1 and the second length L2 corresponding to the first length L1 may also satisfy the following description. The second length L2 may be about 4.2 to about 5.2 times, about 4.3 to about 5.2 times, about 4.4 to about 5.2 times, about 4.5 to about 5.2 times, about 4.6 to about 5.2 times, about 4.7 to about 5.2 times, about 4.8 to about 5.2 times, about 4.9 to about 5.2 times, about 5 to about 5.2 times, about 5.1 to about 5.2 times, about 4.15 to about 5 times, about 4.2 to about 5 times, about 4.3 to about 5 times, about 4.4 to about 5 times, about 4.5 to about 5 times, about 4.6 to about 5 times, about 4.7 to about 5 times, about 4.8 to about 5 times, about 4.9 to about 5 times, about 4.15 to about 4.8 times, about 4.2 to about 4.8 times, about 4.3 to about 4.8 times, about 4.4 to about 4.8 times, about 4.5 to about 4.8 times, about 4.6 to about 4.8 times, or about 4.7 to about 4.8 times, the first length L1.

In greater detail, the first length L1 may be about 45 to about 90 micrometers (μm) or about 45 to about 50 μm. The second length L2 may be about 185 to about 470 μm or about 185 to about 260 μm. It should be understood that the above magnitude ranges of the first length L1 and the second length L2 are for illustrative purposes only and are not intended to limit the present invention. Those of ordinary skill in the art may flexibly select the magnitude ranges of the first length L1 and the second length L2 depending on practical requirements.

In greater detail, the first metal mesh units 121 may be in a diamond shape or in a rectangular shape. It should be understood that the above shape of the first metal mesh units 121 is for illustrative purposes only and is not intended to limit the present invention. Those of ordinary skill in the art may flexibly select the shape of the first metal mesh units 121 depending on practical requirements.

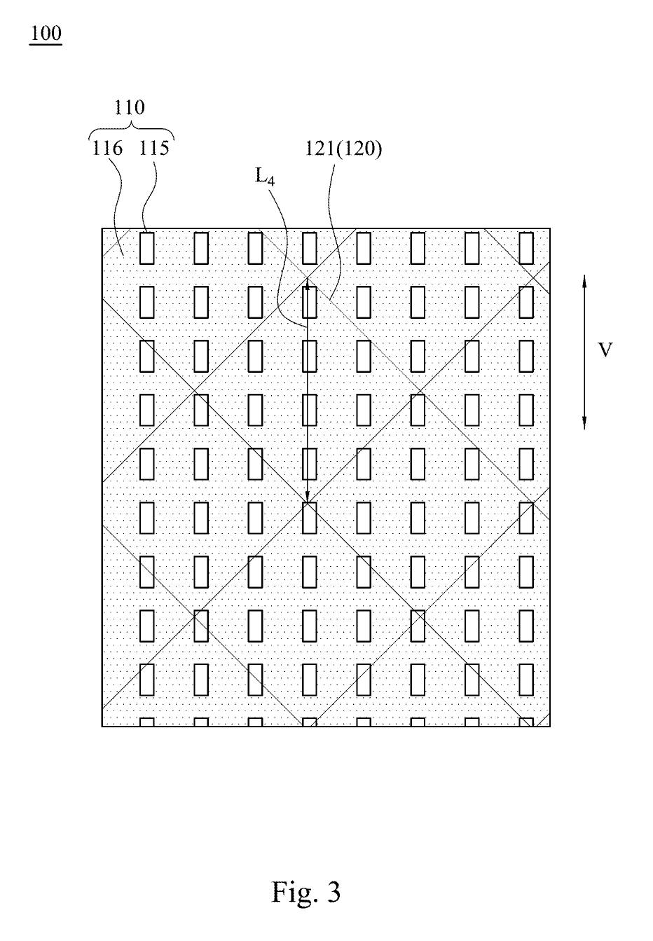

FIG. 3 depicts a top schematic diagram of the touch display panel structure 100 when displaying a pure green picture according to another embodiment of this invention. Since the touch display panel structure 100 according to the present embodiment is approximately the same as the touch display panel structure 100 according to the previous embodiment, only their difference is provided.

As shown in FIG. 3, the pixel units 111 further have a third length L3 (see FIG. 2) along a vertical direction V, respectively. The first metal mesh units 121 further have a fourth length L4 along the vertical direction V, respectively. The fourth length L4 is about 4.15 to about 5.2 times the third length L3.

A relationship between the third length L3 and the fourth length L4 corresponding to the third length L3 may also satisfy the following description. The fourth length L4 may be about 4.2 to about 5.2 times, about 4.3 to about 5.2 times, about 4.4 to about 5.2 times, about 4.5 to about 5.2 times, about 4.6 to about 5.2 times, about 4.7 to about 5.2 times, about 4.8 to about 5.2 times, about 4.9 to about 5.2 times, about 5 to about 5.2 times, about 5.1 to about 5.2 times, about 4.15 to about 5 times, about 4.2 to about 5 times, about 4.3 to about 5 times, about 4.4 to about 5 times, about 4.5 to about 5 times, about 4.6 to about 5 times, about 4.7 to about 5 times, about 4.8 to about 5 times, about 4.9 to about 5 times, about 4.15 to about 4.8 times, about 4.2 to about 4.8 times, about 4.3 to about 4.8 times, about 4.4 to about 4.8 times, about 4.5 to about 4.8 times, about 4.6 to about 4.8 times, or about 4.7 to about 4.8 times, the third length L3.

In greater detail, the third length L3 may be about 45 to about 90 μm or about 45 to about 50 μm. The fourth length L4 may be about 185 to about 470 pm or about 185 to about 260 μm. It should be understood that the above magnitude ranges of the third length L3 and the fourth length L4 are for illustrative purposes only and are not intended to limit the present invention. Those of ordinary skill in the art may flexibly select the magnitude ranges of the third length L3 and the fourth length L4 depending on practical requirements.

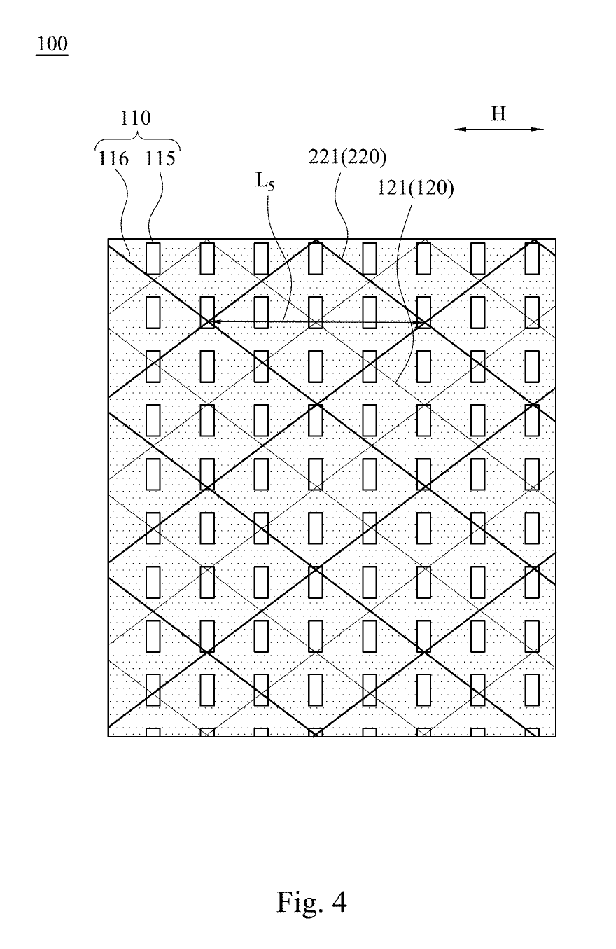

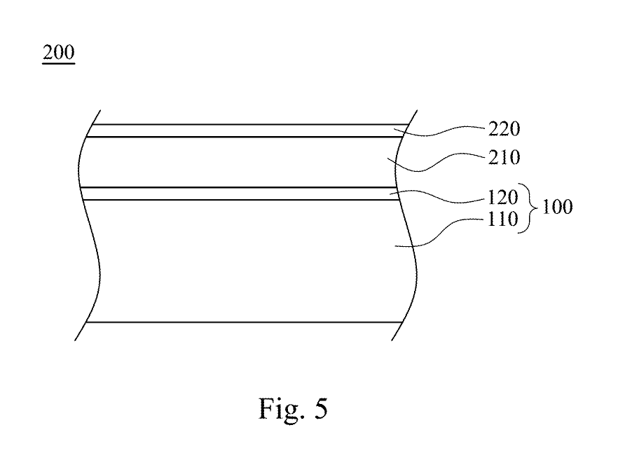

FIG. 4 depicts a top schematic diagram of a touch display panel 200 when displaying a pure green picture according to one embodiment of this invention. FIG. 5 depicts a cross-sectional schematic diagram of the touch display panel 200 of FIG. 4. As shown in FIG. 4 and FIG. 5, a touch display panel 200 comprises the touch display panel structure 100 of FIG. 1, a touch substrate 210, and a second metal mesh 220. The touch substrate 210 is disposed on the first metal mesh 120. The second metal mesh 220 is disposed on the touch substrate 210. The second metal mesh 220 comprises a plurality of second metal mesh units 221. The second metal mesh units 221 respectively have a fifth length L5 along the horizontal direction H. The fifth length L5 is about 4.15 to about 5.2 times the first length L1 (see FIG. 2).

A relationship between the first length L1 and the fifth length L5 corresponding to the first length L1 may also satisfy the following description. The fifth length L5 may be about 4.2 to about 5.2 times, about 4.3 to about 5.2 times, about 4.4 to about 5.2 times, about 4.5 to about 5.2 times, about 4.6 to about 5.2 times, about 4.7 to about 5.2 times, about 4.8 to about 5.2 times, about 4.9 to about 5.2 times, about 5 to about 5.2 times, about 5.1 to about 5.2 times, about 4.15 to about 5 times, about 4.2 to about 5 times, about 4.3 to about 5 times, about 4.4 to about 5 times, about 4.5 to about 5 times, about 4.6 to about 5 times, about 4.7 to about 5 times, about 4.8 to about 5 times, about 4.9 to about 5 times, about 4.15 to about 4.8 times, about 4.2 to about 4.8 times, about 4.3 to about 4.8 times, about 4.4 to about 4.8 times, about 4.5 to about 4.8 times, about 4.6 to about 4.8 times, or about 4.7 to about 4.8 times, the first length L1.

In greater detail, the fifth length L5 may be about 185 to about 470 μm or about 185 to about 260 μm. It should be understood that the above magnitude range of the fifth length L5 is for illustrative purposes only and is not intended to limit the present invention. Those of ordinary skill in the art may flexibly select the magnitude range of the fifth length L5 depending on practical requirements.

In greater detail, an orthogonal projection of the first metal mesh units 121 on the display panel 110 (or the touch substrate 210) is interlaced with an orthogonal projection of the second metal mesh units 221 on the display panel 110 (or the touch substrate 210). It should be understood that the above first metal mesh units 121 and second metal mesh units 221 are for illustrative purposes only and are not intended to limit the present invention. Those of ordinary skill in the art may flexibly select the first metal mesh units 121 and the second metal mesh units 221 depending on practical requirements.

In the following, experimental data for the embodiment shown in FIG. 1 to FIG. 2 are disclosed to prove that the touch display panel structure 100 in FIG. 1 and FIG. 2 can really increase the average aperture ratio of the pixel units 111 so as to improve the display brightness of the touch display panel structure 100. In the following description, parameters have been provided in the above embodiments will not be described repeatedly, and a description is only provided to the parameters that need to be further defined supplementarily.

In the comparison example and the embodiment, shapes of display faces of the touch display panel structures 100 are both a rectangle, and a length of a diagonal of the rectangle is 7.8 inches. Pixels per inch (PPI) of the pixel units 111 are both 324, and the first length L1 and the third length L3 are both 78 μm. In the comparison example, the second length L2 is 319 μm, and the fourth length L4 is 211 μm. Hence, the second length L2 is 4.1 times the first length L1, and the fourth length L4 is 2.7 times the third length L3. The average aperture ratio of the pixel units 111 is 95% when the touch display panel structure 100 displays the pure green picture. In the embodiment, the second length L2 and the fourth length L4 are both 390 μm. Hence, the second length L2 is five times the first length L1, and the fourth length L4 is five times the third length L3. The average aperture ratio of the pixel units 111 is 97% when the touch display panel structure 100 displays the pure green picture. The average aperture ratio of the pixel units 111 according to the embodiment is really higher than the average aperture ratio of the pixel units 111 according to the comparison example.

According to the embodiments of the present invention, the second length L2 of the first metal mesh unit 121 is rendered to be about 4.15 to about 5.2 times the first length L1 of the pixel unit 111. As a result, a distribution of the pixel units 111 having a decreased aperture ratio due to the blockage of the pixel units 111 by the metal wires of the first metal mesh 120 and the pixel units 111 not being blocked by the metal wires of the first metal mesh 120 is more uniform. A naked eye will not observe the mura phenomenon of the display picture. At the same time, since the distribution of the first metal mesh units 121 is much more sparse than that of the pixel units 111, the blockage of the display panel 110 by the first metal mesh 120 is reduced to effectively increase the average aperture ratio of the pixel units 111 so as to improve the display brightness of the touch display panel structure 100.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch display panel structure comprising:
a display panel comprising:
a plurality of pixel units respectively having a first length along a horizontal direction; and
a first metal mesh disposed on the display panel comprising:
a plurality of first metal mesh units respectively having a second length along the horizontal direction, wherein the second length is about 4.15 to about 5.2 times the first length.

2. The touch display panel structure of claim 1, wherein the second length is about 4.15 to about 5 times the first length.

3. The touch display panel structure of claim 1, wherein the second length is about 4.3 to about 5.2 times the first length.

4. The touch display panel structure of claim 1, wherein the second length is about 4.5 to about 5.2 times the first length.

5. The touch display panel structure of claim 1, wherein the first length is about 45 to about 90 μm.

6. The touch display panel structure of claim 1, wherein the second length is about 185 to about 470 μm.

7. The touch display panel structure of claim 1, wherein the first metal mesh units are in a rectangular shape or in a diamond shape.

8. The touch display panel structure of claim 1, wherein the pixel units further have a third length along a vertical direction, respectively, the first metal mesh units further have a fourth length along the vertical direction, respectively, the fourth length is about 4.15 to about 5.2 times the third length.

9. The touch display panel structure of claim 8, wherein the fourth length is about 4.15 to about 5 times the third length.

10. The touch display panel structure of claim 8, wherein the fourth length is about 4.3 to about 5.2 times the third length.

11. The touch display panel structure of claim 8, wherein the fourth length is about 4.5 to about 5.2 times the third length.

12. A touch display panel comprising:
the touch display panel structure of claim 1;
a touch substrate disposed on the first metal mesh; and
a second metal mesh disposed on the touch substrate comprising:
a plurality of second metal mesh units respectively having a fifth length along the horizontal direction, wherein the fifth length is about 4.15 to about 5.2 times the first length.

13. The touch display panel of claim 12, wherein the fifth length is about 4.15 to about 5 times the first length.

14. The touch display panel of claim 12, wherein the fifth length is about 4.3 to about 5.2 times the first length.

15. The touch display panel of claim 12, wherein an orthogonal projection of the first metal mesh units on the display panel is interlaced with an orthogonal projection of the second metal mesh units on the display panel.
